(19) United States
(12) Patent Application Publication
(10) Pub. No.: US 2026/0184615 A1
(43) Pub. Date: Jul. 2, 2026

(54) WASTEWATER TREATMENT APPARATUS AND WASTEWATER TREATMENT METHOD

(71) Applicant: Samsung Electronics Co., Ltd., Suwon-si (KR)

(72) Inventors: Jehun Kim, Suwon-si (KR); Wooram Lee, Suwon-si (KR); Yongju Choi, Seoul (KR); Changmin Lee, Seoul (KR); Junhyuk Chung, Seoul (KR); Soojin Shim, Suwon-si (KR)

(73) Assignee: Seoul National University R&DB Foundation, Seoul (KR)

(21) Appl. No.: 19/387,380

(22) Filed: Nov. 12, 2025

(30) Foreign Application Priority Data
Dec. 31, 2024 (KR) 10-2024-0202661

(51) Int. Cl. C02F 9/00; C02F 1/00; C02F 1/52; C02F 1/68; C02F 101/10

(52) U.S. Cl. CPC C02F 9/00; C02F 1/004; C02F 1/5245; C02F 1/68; C02F 2101/101

(57) ABSTRACT

A wastewater treatment apparatus includes a wastewater storage tank configured to store wastewater including sulfate ions, a first reactor configured to generate calcium sulfate by receiving the wastewater and an aqueous calcium salt, a second reactor configured to accelerate the generation of calcium sulfate by receiving first effluent supplied from the first reactor and a hydrophilic alcohol, a first separator configured to separate calcium sulfate from second effluent supplied from the second reactor, a third reactor configured to generate barium sulfate by receiving third effluent supplied from the first separator and an aqueous barium salt, a second separator configured to separate barium sulfate from fourth effluent supplied from the third reactor, and a treated water storage tank configured to store treated water filtered by the second separator.

### CROSS-REFERENCE TO RELATED APPLICATION

This application is based on and claims priority under 35 U.S.C. § 119 to Korean Patent Application No. 10-2024-0202661, filed on Dec. 31, 2024, in the Korean Intellectual Property Office, the disclosure of which is incorporated by reference herein in its entirety.

### BACKGROUND

In many industrial fields such as the semiconductor industry and the like, large volumes of liquid containing sulfur-based compounds may be generated. These liquids may often be subject to various handling and processing operations.

### SUMMARY

In many industrial fields, a large amount of wastewater including sulfuric acid may be generated. When high-concentration sulfate ions in semiconductor-industry wastewater may be discharged to rivers or the like without undergoing appropriate treatment, the sulfate ion concentration and the electrical conductivity in rivers or the like may increase. When the sulfate ion concentration and the electrical conductivity in rivers or the like are increased, there may be adverse influences on agricultural areas and the animal and plant kingdoms around rivers or the like. For example, there may be an issue in that the increase in the sulfate ion concentration and the electrical conductivity may cause blight of crops due to osmotic pressure and may hinder the cell death and growth of plants and animals due to changes in osmotic environments. Therefore, it may be desired to treat sulfate ions in wastewater.

Implementations according to present disclosure provide a wastewater treatment apparatus and a wastewater treatment method for removing sulfate ions in wastewater by using calcium hydroxide, 2-propanol, and barium hydroxide.

In general, in some aspects, the present disclosure provides a wastewater treatment apparatus. The wastewater treatment apparatus includes a wastewater storage tank configured to store wastewater including sulfate ions, a first reactor configured to generate calcium sulfate by receiving the wastewater and an aqueous calcium salt, a second reactor configured to accelerate the generation of calcium sulfate by receiving first effluent and a hydrophilic alcohol, the first effluent being supplied from the first reactor, a first separator configured to separate calcium sulfate from second effluent that is supplied from the second reactor, a third reactor configured to generate barium sulfate by receiving third effluent and an aqueous barium salt, the third effluent being supplied from the first separator, a second separator configured to separate barium sulfate from fourth effluent that is supplied from the third reactor, and a treated water storage tank configured to store treated water that is filtered by the second separator.

In general, in some aspects, the present disclosure provides a wastewater treatment method. The wastewater treatment method includes storing, in a wastewater storage tank, wastewater including sulfate ions, performing a first reaction to generate calcium sulfate by supplying an aqueous calcium salt to the wastewater supplied from the wastewater storage tank, performing first reaction acceleration to accelerate the generation of calcium sulfate by supplying a hydrophilic alcohol to first effluent that is generated in the first reaction, performing first separation to separate calcium sulfate from second effluent that is generated in the first reaction acceleration, performing a second reaction to generate barium sulfate by supplying an aqueous barium salt to third effluent that is generated in the first separation, performing second separation to separate barium sulfate from fourth effluent that is generated in the second reaction, and storing treated water that is filtered through the second separation.

In general, in some aspects, the present disclosure provides a wastewater treatment method. The wastewater treatment method includes storing, in a wastewater storage tank, wastewater including sulfate ions, performing a first reaction to generate calcium sulfate by supplying an aqueous calcium salt to the wastewater supplied from the wastewater storage tank, performing a second reaction to generate barium sulfate by supplying an aqueous barium salt to first effluent that is generated in the first reaction, separating calcium sulfate and barium sulfate from second effluent that is generated in the second reaction, and storing treated water that is filtered through the separating of calcium sulfate and barium sulfate.

### BRIEF DESCRIPTION OF THE DRAWINGS

FIG. 1 is a diagram illustrating an example of a wastewater treatment apparatus.

FIG. 2 is a flowchart illustrating an example wastewater treatment method.

FIG. 3 is a flowchart illustrating an example wastewater treatment method.

FIG. 4 is a table illustrating the state of wastewater in an example wastewater treatment method.

FIG. 5 is a table illustrating the concentration of sulfate ions in wastewater that has been treated according to an example wastewater treatment method.

### DETAILED DESCRIPTION

Hereinafter, implementations of the inventive concept will be described in detail with reference to the accompanying drawings. Like components are denoted by like reference numerals throughout the specification, and repeated descriptions thereof are omitted.

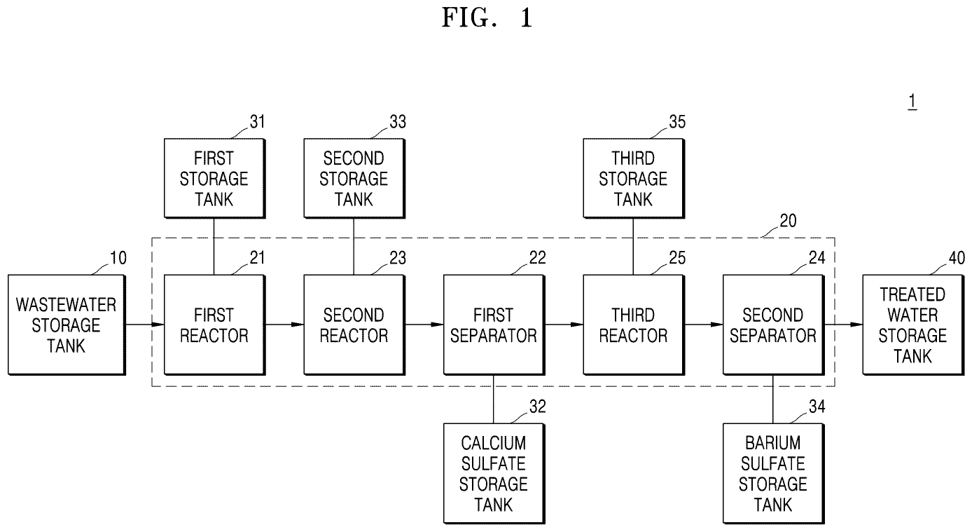

FIG. 1 is a diagram schematically illustrating an example of a wastewater treatment apparatus.

Referring to FIG. 1, a wastewater treatment apparatus 1 may include a wastewater storage tank 10, a reactor 20, and a treated water storage tank 40. Wastewater including sulfate ions (referred to as “sulfate wastewater”, hereinafter) may be discharged from the wastewater storage tank 10 and supplied to the reactor 20, followed by reducing the concentration of sulfate ions in the wastewater in the reactor 20, and then, may be supplied to the treated water storage tank 40.

In some implementations, the wastewater storage tank 10 may store sulfate wastewater generated in industrial fields, such as the semiconductor industry, the metal industry, the fertilizer industry, the pesticide manufacturing industry, and the like. For example, the sulfate wastewater may be generated in processes using sulfuric acid from among semiconductor manufacturing processes.

In some implementations, the wastewater storage tank 10 may store high-concentration sulfate wastewater. For example, the sulfate wastewater may include 5,000 mg/L or more of sulfate ions. The sulfate wastewater may include acidic wastewater having a pH of about 0 to about 3. In addition, the sulfate wastewater may include various components, such as metal materials, semiconductor materials, inorganic compounds, metal oxides, and the like. Here, the wastewater storage tank 10 may include a pump for wastewater supply so as to supply the sulfate wastewater from the wastewater storage tank 10 to the reactor 20.

In some implementations, the reactor 20 may include a first reactor 21, a second reactor 23, a third reactor 25, a first separator 22, and a second separator 24. The first reactor 21, the second reactor 23, the first separator 22, the third reactor 25, and the second separator 24 may be configured to be sequentially connected to each other in the stated order, but the inventive concept is not limited thereto.

In some implementations, the sulfate wastewater may be supplied from the wastewater storage tank 10 to the first reactor 21. An aqueous calcium salt may be supplied from a first storage tank 31 to the first reactor 21. The aqueous calcium salt may be a chemical that is dissolved in water and provides a calcium ion (Ca²⁺). For example, the aqueous calcium salt may include, but is not limited to, calcium hydroxide (Ca(OH)₂).

In some implementations, the first storage tank 31 may be connected to the first reactor 21. The first storage tank 31 may store the aqueous calcium salt (for example, calcium hydroxide) and may supply the aqueous calcium salt to the first reactor 21.

In some implementations, the first reactor 21 may perform a calcium sulfate (CaSO₄) precipitation reaction. The sulfate wastewater and calcium hydroxide may be supplied to the first reactor 21, thereby generating calcium sulfate. For example, a chemical reaction as shown below in Chemical Equation 1 may occur in the first reactor 21. Here, calcium hydroxide may be supplied in a solid state or an aqueous solution state to the first reactor 21.

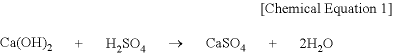

In some implementations, the first reactor 21 may include a pH meter for measuring the pH of the sulfate wastewater of the first reactor 21. The amount of calcium hydroxide supplied may be adjusted according to a pH value measured by the pH meter. The amount of calcium hydroxide may be adjusted such that the pH of the sulfate wastewater reaches about 5 to about 7. As calcium hydroxide is supplied to the first reactor 21, the pH in the first reactor 21 may be increased. For example, calcium hydroxide may be supplied from the first storage tank 31 to the first reactor 21 such that the pH of the sulfate wastewater is about 5 to about 7.

In some implementations, the first reactor 21 may include a stirrer capable of mixing the sulfate wastewater with calcium hydroxide. Here, the resolution per minute (rpm) of the stirrer may be about 30 rpm to about 150 rpm, but the inventive concept is not limited thereto. The hydraulic retention time (HRT) of the first reactor 21 may be about 5 minutes to about 15 minutes, but the inventive concept is not limited thereto.

In some implementations, the wastewater treatment apparatus 1 according to the inventive concept may remove sulfate ions in the sulfate wastewater through the chemical reaction according to Chemical Equation 1 in the first reactor 21. After the chemical reaction according to Chemical Equation 1 is performed in the first reactor 21, the sulfate wastewater may be supplied to the second reactor 23. The sulfate wastewater supplied from the first reactor 21 to the second reactor 23 may be referred to as first effluent. Due to the solubility of sulfate ions, even though the chemical reaction according to Chemical Equation 1 is finished, sulfate ions may remain in the first effluent.

In some implementations, the first effluent may be supplied from the first reactor 21 to the second reactor 23. A hydrophilic alcohol may be supplied from the second storage tank 33 to the second reactor 23. For example, the hydrophilic alcohol may include, but is not limited to, 2-propanol.

In some implementations, the second storage tank 33 may be connected to the second reactor 23. The second storage tank 33 may may store the hydrophilic alcohol (for example, 2-propanol) and may supply the hydrophilic alcohol to the second reactor 23.

In some implementations, the second reactor 23 may accelerate a calcium sulfate precipitation reaction. 2-propanol and the first effluent are supplied to the second reactor 23, and 2-propanol may additionally reduce the solubility of sulfate ions in the first effluent, thereby further generating calcium sulfate. For example, the chemical reaction as in Chemical Equation 1 may additionally occur in the second reactor 23. Here, 2-propanol may be supplied from the second storage tank 33 to the second reactor 23 at a concentration of about 10,000 mg/L to about 100,000 mg/L, but the inventive concept is not limited thereto.

In some implementations, the second reactor 23 may include a stirrer capable of mixing the first effluent with 2-propanol. Here, the rpm of the stirrer may be about 30 rpm to about 150 rpm, but the inventive concept is not limited thereto. The HRT of the second reactor 23 may be about 5 minutes to about 15 minutes, but the inventive concept is not limited thereto.

In some implementations, the wastewater treatment apparatus 1 of the inventive concept may remove sulfate ions in the sulfate wastewater through the chemical reaction according to Chemical Equation 1 in the second reactor 23. After the calcium sulfate precipitation reaction additionally occurs in the second reactor 23, the sulfate wastewater may be supplied to the first separator 22. The sulfate wastewater supplied from the second reactor 23 to the first separator 22 may be referred to as second effluent. Due to the solubility of sulfate ions, sulfate ions may remain in the second effluent.

In some implementations, the second effluent may be supplied from the second reactor 23 to the first separator 22. The first separator 22 may include a first press device and a first filter, which are configured to separate calcium sulfate from the second effluent through solid-liquid separation.

In some implementations, the second effluent supplied to the first separator 22 may include polymeric calcium sulfate solids. In the first separator 22, by the driving pressure of the first press device, polymeric calcium sulfate is not able to pass through the first filter, and only a liquid except for calcium sulfate may pass through the first filter. Here, calcium sulfate may be accumulated in a cake shape on the surface of the first filter. That is, the first separator 22 may filter out calcium sulfate in the second effluent through high-pressure separation using the first press device and the first filter.

In some implementations, calcium sulfate accumulated in a cake shape on the surface of the first filter may be transferred to and stored in a separate calcium sulfate storage tank 32. In addition, the wastewater filtered through the high-pressure separation in the first separator 22 may be supplied to the third reactor 25.

In some implementations, the first filter may include polymeric polypropylene (PP), polyethylene (PE), other polymeric materials (for example, nylon), or a combination thereof. In addition, the first press device may be configured to separate calcium sulfate through solid-liquid separation at a driving pressure of about 0.5 bar to about 15 bar.

In some implementations, the sulfate wastewater filtered by the first separator 22 and then supplied to the third reactor 25 may be referred to as third effluent. Due to the solubility of sulfate ions, sulfate ions may remain in the third effluent.

In some implementations, the third effluent may be supplied from the first separator 22 to the third reactor 25. An aqueous barium salt may be supplied from a third storage tank 35 to the third reactor 25. The aqueous barium salt may be a chemical that is dissolved in water and provides a barium ion (Ba²⁺). For example, the aqueous barium salt may include, but is not limited to, barium hydroxide (Ba(OH)₂).

In some implementations, the third storage tank 35 may be connected to the third reactor 25. The third storage tank 35 may store the aqueous barium salt (for example, barium hydroxide) and may supply the aqueous barium salt to the third reactor 25.

In some implementations, the third reactor 25 may perform a barium sulfate (BaSO₄) precipitation reaction. The third effluent and barium hydroxide may be supplied to the third reactor 25, thereby generating barium sulfate. For example, the chemical reaction as in Chemical Equation 2 shown below may occur in the third reactor 25. Here, barium hydroxide may be supplied in a solid state or an aqueous solution state to the third reactor 25.

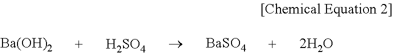

In some implementations, barium hydroxide may be supplied from the third storage tank 35 to the third reactor 25. Here, barium hydroxide may be supplied at a concentration of about 300 mg/L to about 30,000 mg/L to the third reactor 25, but the inventive concept is not limited thereto. The amount of barium hydroxide supplied may be determined by estimating the concentration of sulfate ions in the third effluent from the solubility of calcium sulfate. For example, the amount of barium hydroxide supplied may be determined to be about 0.1 to about 10 of the solubility of calcium sulfate, but the inventive concept is not limited thereto.

In some implementations, 2-propanol, which has been supplied to the second reactor 23, may remain in the third effluent supplied to the third reactor 25. 2-propanol, which has been left after accelerating the calcium sulfate precipitation reaction in the second reactor 23, may additionally reduce the solubility of sulfate ions in the third effluent, thereby further generating barium sulfate.

In some implementations, the third reactor 25 may include a stirrer capable of mixing the third effluent with barium hydroxide. Here, the rpm of the stirrer may be about 30 rpm to about 150 rpm, but the inventive concept is not limited thereto. The HRT of the third reactor 25 may be about 10 minutes to about 30 minutes, but the inventive concept is not limited thereto.

In some implementations, the wastewater treatment apparatus 1 of the inventive concept may additionally remove sulfate ions in the sulfate wastewater through the chemical reaction according to Chemical Equation 2 in the third reactor 25. After the chemical reaction according to Chemical Equation 2 is performed in the third reactor 25, the sulfate wastewater may be supplied to the second separator 24. The sulfate wastewater supplied from the third reactor 25 to the second separator 24 may be referred to as fourth effluent. Due to the solubility of sulfate ions, sulfate ions may remain in the fourth effluent.

In some implementations, the fourth effluent may be supplied from the third reactor 25 to the second separator 24. The second separator 24 may include a second press device and a second filter, which are configured to separate barium sulfate from the fourth effluent through solid-liquid separation.

In some implementations, the fourth effluent supplied to the second separator 24 may include polymeric barium sulfate particles. In the second separator 24, by the driving pressure of the second press device, polymeric barium sulfate is not able to pass through the second filter, and only a liquid except for barium sulfate may pass through the second filter. Here, barium sulfate may be accumulated in a cake shape on the surface of the second filter. That is, the second separator 24 may filter out barium sulfate in the fourth effluent through high-pressure separation using the second press device and the second filter.

In some implementations, the second filter may include polymeric PP, PE, other polymeric materials (for example, nylon), or a combination thereof. In addition, the second press device may be configured to separate barium sulfate through solid-liquid separation at a driving pressure of about 0.5 bar to about 15 bar.

In some implementations, barium sulfate accumulated in a cake shape on the surface of the second filter may be transferred to and stored in a separate barium sulfate storage tank 34. In addition, the wastewater filtered through the high-pressure separation in the second separator 24 may be supplied to the treated water storage tank 40. The sulfate wastewater filtered by the second separator 24 and supplied to the treated water storage tank 40 may be referred to as treated water.

In some implementations, the treated water storage tank 40 may store the treated water that is discharged from the wastewater storage tank 10 and then filtered by the reactor 20. Here, the concentration of sulfate ions in the treated water may be less than 10 mg/L, but the inventive concept is not limited thereto.

When a wastewater treatment apparatus according to a comparative example removes sulfate ions by using only calcium hydroxide, there is a limit in removing sulfate ions in wastewater due to the solubility of sulfate ions. For example, the concentration of sulfate ions in wastewater may be reduced to a level of about 1,000 mg/L to about 3,000 mg/L.

The wastewater treatment apparatus 1 of the inventive concept may remove sulfate ions in wastewater by using calcium hydroxide, 2-propanol, and barium hydroxide together. The concentration of sulfate ions in wastewater may be effectively reduced by using a combination of the barium sulfate precipitation reaction and the calcium sulfate precipitation reaction and using an effect of 2-propanol accelerating the sulfate ion precipitation. For example, the concentration of sulfate ions in wastewater may be reduced to a level of about 4 mg/L.

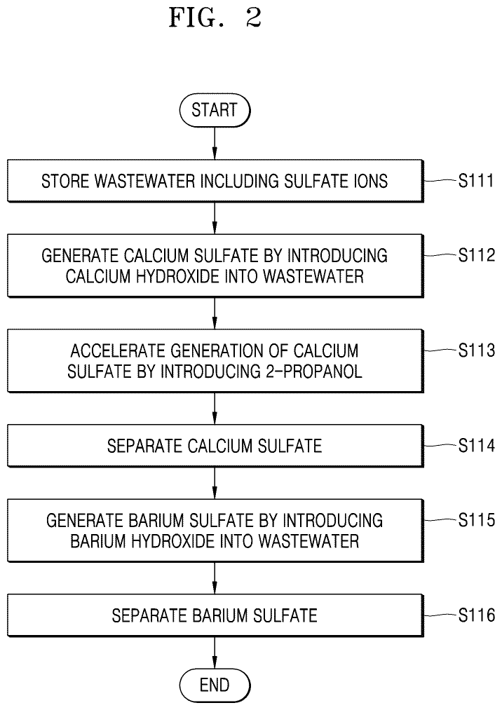

FIG. 2 is a flowchart illustrating an example wastewater treatment method. Regarding FIG. 2, repeated descriptions already given with reference to FIG. 1 are omitted.

Referring to FIGS. 1 and 2, the wastewater treatment method of the inventive concept may store, in the wastewater storage tank 10, wastewater (referred to as sulfate wastewater, hereinafter) including sulfate ions (S111). Here, the sulfate wastewater may include high-concentration sulfate wastewater including 5,000 mg/L or more of sulfate ions. In addition, the sulfate wastewater may include acidic wastewater having a pH of about 0 to about 3.

In some implementations, the wastewater treatment method of the inventive concept may generate calcium sulfate by introducing an aqueous calcium salt to the sulfate wastewater supplied from the wastewater storage tank 10 (S112). The sulfate wastewater and calcium hydroxide (Ca(OH)₂) may be supplied to the first reactor 21, thereby generating calcium sulfate. For example, the chemical reaction as in Chemical Equation 1 shown below may occur in the first reactor 21. Here, the amount of calcium hydroxide supplied may be adjusted according to the pH value of the sulfate wastewater. The amount of calcium hydroxide may be adjusted such that the pH of the sulfate wastewater reaches about 5 to about 7.

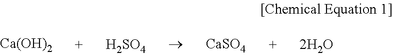

In some implementations, the wastewater treatment method of the inventive concept may accelerate the generation of calcium sulfate by introducing a hydrophilic alcohol to first effluent supplied from the first reactor 21 (S113). The first effluent and 2-propanol may be supplied to the second reactor 23, thereby accelerating a calcium sulfate precipitation reaction. 2-propanol may additionally reduce the solubility of sulfate ions in the first effluent, thereby further generating calcium sulfate. Here, 2-propanol may be supplied at a concentration of about 10,000 mg/L to about 100,000 mg/L to the second reactor 23, but the inventive concept is not limited thereto.

In some implementations, the wastewater treatment method of the inventive concept may separate calcium sulfate from second effluent supplied from the second reactor 23 (S114). The first separator 22 may separate calcium sulfate from the second effluent through solid-liquid separation by using a first press device and a first filter. In the first separator 22, calcium sulfate may be accumulated in a cake shape, and thus, calcium sulfate in the second effluent may be filtered out.

In some implementations, the wastewater treatment method of the inventive concept may generate barium sulfate by introducing an aqueous barium salt to third effluent supplied from the first separator 22 (S115). The sulfate wastewater and barium hydroxide (Ba(OH)₂) may be supplied to the third reactor 25, thereby generating barium sulfate. For example, the chemical reaction as in Chemical Equation 2 shown below may occur in the third reactor 25. Here, barium hydroxide may be supplied at a concentration of about 300 mg/L to about 30,000 mg/L to the third reactor 25, but the inventive concept is not limited thereto.

In some implementations, 2-propanol, which has been supplied to the second reactor 23, may remain in the third effluent supplied to the third reactor 25. 2-propanol, which has been left after accelerating the calcium sulfate precipitation reaction in the second reactor 23, may additionally reduce the solubility of sulfate ions in the third effluent, thereby further generating barium sulfate.

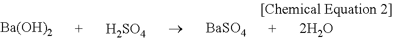

In some implementations, the wastewater treatment method of the inventive concept may separate barium sulfate from fourth effluent supplied from the third reactor 25 (S116). The second separator 24 may separate barium sulfate from the fourth effluent through solid-liquid separation by using a second press device and a second filter. In the second separator 24, barium sulfate may be accumulated in a cake shape, and thus, barium sulfate in the fourth effluent may be filtered out.

In some implementations, the wastewater treatment method of the inventive concept may store treated water that is filtered through high-pressure separation in the second separator 24. The sulfate wastewater filtered by the second separator 24 and then supplied to the treated water storage tank 40 may be referred to as treated water. Here, the concentration of sulfate ions in the treated water may be 10 mg/L or less, but the inventive concept is not limited thereto.

When a wastewater treatment method according to a comparative example removes sulfate ions by using only calcium hydroxide, there is a limit in removing sulfate ions in wastewater due to the solubility of sulfate ions. For example, the concentration of sulfate ions in wastewater may be reduced to a level of about 1,000 mg/L to about 3,000 mg/L.

The wastewater treatment method of the inventive concept may remove sulfate ions in wastewater by using calcium hydroxide, 2-propanol, and barium hydroxide together. The concentration of sulfate ions in wastewater may be effectively reduced by using a combination of the barium sulfate precipitation reaction and the calcium sulfate precipitation reaction and using an effect of 2-propanol accelerating the sulfate ion precipitation.

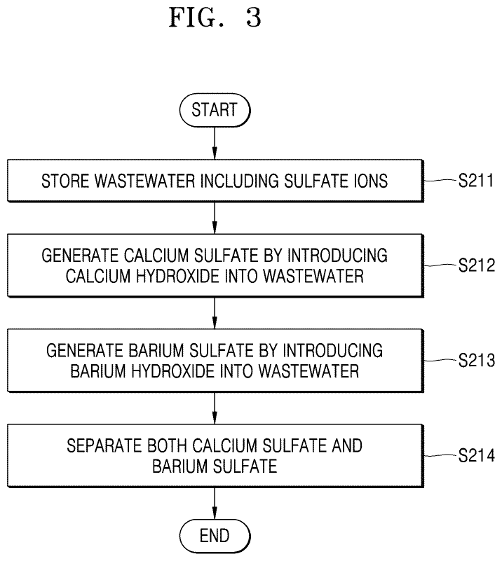

FIG. 3 is a flowchart illustrating an example wastewater treatment method.

Referring to FIG. 3, the wastewater treatment method of the inventive concept may be similar to the wastewater treatment method described with reference to FIG. 2 on the whole except for accelerating the generation of calcium sulfate and barium sulfate by the introduction of 2-propanol. Regarding FIG. 3, repeated descriptions already given with reference to FIG. 2 are omitted.

In some implementations, the wastewater treatment method of the inventive concept may store, in the wastewater storage tank 10 (see FIG. 1), wastewater (referred to as sulfate wastewater, hereinafter) including sulfate ions (S211).

In some implementations, the wastewater treatment method of the inventive concept may generate calcium sulfate by introducing an aqueous calcium salt to the sulfate wastewater supplied from the wastewater storage tank 10 (S212). The sulfate wastewater and calcium hydroxide (Ca(OH)2) may be supplied to the first reactor 21 (see FIG. 1), thereby generating calcium sulfate.

In some implementations, the wastewater treatment method of the inventive concept may generate barium sulfate by introducing an aqueous barium salt to first effluent supplied from the first reactor 21 (S213). The sulfate wastewater and barium hydroxide (Ba(OH)₂) may be supplied to the third reactor 25 (see FIG. 1), thereby generating barium sulfate. That is, in a wastewater treatment apparatus configured to perform the wastewater treatment method of FIG. 3, the second reactor 23 and the first separator 22 may be omitted, and the first reactor 21 and the third reactor 25 may be connected to each other.

In some implementations, the wastewater treatment method of the inventive concept may separate calcium sulfate and barium sulfate from second effluent supplied from the third reactor 25. The second separator 24 (see FIG. 1) may separate calcium sulfate and barium sulfate from the second effluent through solid-liquid separation by using a press device and a filter. Next, treated water filtered through high-pressure separation may be stored.

The wastewater treatment method of the inventive concept may remove sulfate ions in wastewater by using calcium hydroxide and barium hydroxide together. The concentration of sulfate ions in wastewater may be effectively reduced by using a combination of the barium sulfate precipitation reaction and the calcium sulfate precipitation reaction.

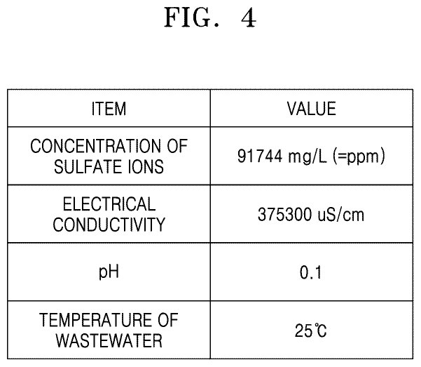

FIG. 4 is a table illustrating the state of wastewater in an example wastewater treatment method.

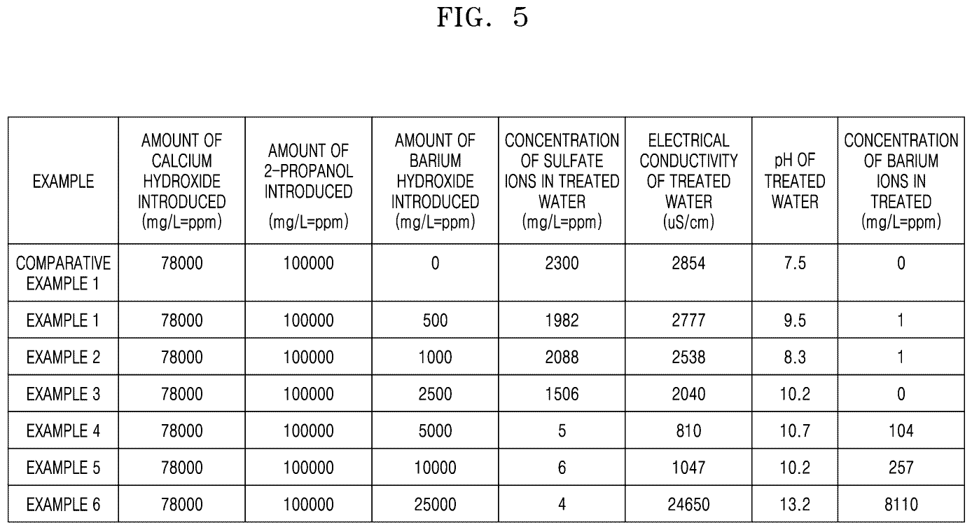

FIG. 5 is a table illustrating the concentration of sulfate ions in wastewater that has been treated according to an example wastewater treatment method.

Specifically, FIG. 4 is a table illustrating the state of wastewater supplied to the wastewater treatment apparatus 1 of FIG. 1, and FIG. 5 is a table illustrating a result of supplying calcium hydroxide, 2-propanol, and barium hydroxide to the wastewater supplied to the wastewater treatment apparatus 1 of FIG. 1.

Referring to FIG. 4, sulfate wastewater supplied to the wastewater storage tank 10 (see FIG. 1) may include 91,744 mg/L of sulfate ions. In addition, the sulfate wastewater may have a pH of 0.1, a temperature of 25° C., and an electrical conductivity of 3,575,300 uS/cm.

In some implementations, the sulfate wastewater may be transferred from the wastewater storage tank 10 to the first reactor 21 (see FIG. 1), and then, calcium hydroxide (Ca(OH)₂) may be supplied to the first reactor 21. Calcium hydroxide may be supplied such that the pH of the sulfate wastewater reaches about 5 to about 7. 78,000 mg/L of calcium hydroxide may be supplied to the first reactor 21.

In some implementations, the first reactor 21 may mix the sulfate wastewater with calcium hydroxide by using a stirrer. In the first reactor 21, the rpm of the stirrer may be adjusted to about 30 rpm to about 150 rpm, and a reaction between the sulfate wastewater and calcium hydroxide may be performed for 15 minutes. After the reaction, first effluent including calcium sulfate solids may be generated.

In some implementations, the first effluent may be transferred from the first reactor 21 to the second reactor 23 (see FIG. 1), and then, 2-propanol may be supplied to the second reactor 23. Here, 100,000 mg/L of 2-propanol may be supplied.

In some implementations, the second reactor 23 may mix the first effluent with 2-propanol by using a stirrer. In the second reactor 23, the rpm of the stirrer may be adjusted to about 30 rpm to about 150 rpm, and a reaction between the first effluent and 2-propanol may be performed for 10 minutes. After the reaction, second effluent including calcium sulfate solids may be generated.

In some implementations, the second effluent may be transferred from the second reactor 23 to the first separator 22 (see FIG. 1), and then, calcium sulfate may be separated from the second effluent through solid-liquid separation in the first separator 22.

In some implementations, the second effluent supplied to the first separator 22 may include polymeric calcium sulfate solids. In the first separator 22, by the driving pressure (for example, 1 bar) of a press device, polymeric calcium sulfate is not able to pass through a polymer filter, and only a liquid except for calcium sulfate may pass through the polymer filter. Here, calcium sulfate may be accumulated in a cake shape on the surface of the polymer filter. That is, the first separator 22 may filter out calcium sulfate in the second effluent through high-pressure separation using the press device and the polymer filter.

In some implementations, the sulfate wastewater filtered by the first separator 22 and then supplied to the third reactor 25 may be referred to as third effluent. Due to the solubility of sulfate ions, sulfate ions may remain in the third effluent.

In some implementations, the third effluent may be transferred from the first separator 22 to the third reactor 25 (see FIG. 1), and then, barium hydroxide (Ba(OH)₂) may be supplied to the third reactor 25. The wastewater treatment method of the inventive concept may supply barium hydroxide at 500 mg/L, 1,000 mg/L, 2,500 mg/L, 5,000 mg/L, 10,000 mg/L, or 25,000 mg/L. In addition, the wastewater treatment method according to the comparative example may not supply barium hydroxide.

In some implementations, the third reactor 25 may mix the third effluent with barium hydroxide by using a stirrer. In the third reactor 25, the rpm of the stirrer may be adjusted to about 30 rpm to about 150 rpm, and a reaction between the third effluent and barium hydroxide may be performed for about 10 minutes to about 30 minutes. After the reaction, fourth effluent including barium sulfate solids may be generated.

In some implementations, the fourth effluent may be transferred from the third reactor 25 to the second separator 24 (see FIG. 1), and then, barium sulfate may be separated from the fourth effluent through solid-liquid separation.

In some implementations, the fourth effluent supplied to the second separator 24 may include polymeric barium sulfate solids. In the second separator 24, by the driving pressure (for example, 1 bar) of a press device, polymeric barium sulfate is not able to pass through a polymer filter, and only a liquid except for barium sulfate may pass through the polymer filter. Here, barium sulfate may be accumulated in a cake shape on the surface of the polymer filter. That is, the second separator 24 may filter out barium sulfate in the fourth effluent through high-pressure separation using the press device and the polymer filter. Next, treated water filtered by the second separator 24 may be supplied to and stored in the treated water storage tank 40.

Referring again to FIG. 4, it may be confirmed that, as the concentration of barium hydroxide increases, the concentration of sulfate ions tends to decrease. For example, when the concentration of barium hydroxide is 500 mg/L, the concentration of sulfate ions in the treated water may be 1,982 mg/L. When the concentration of barium hydroxide is 1,000 mg/L, the concentration of sulfate ions in the treated water may be 2,088 mg/L. When the concentration of barium hydroxide is 2,500 mg/L, the concentration of sulfate ions in the treated water may be 1,506 mg/L. When the concentration of barium hydroxide is 5,000 mg/L, the concentration of sulfate ions in the treated water may be 5 mg/L. When the concentration of barium hydroxide is 10,000 mg/L, the concentration of sulfate ions in the treated water may be 6 mg/L. When the concentration of barium hydroxide is 25,000 mg/L, the concentration of sulfate ions in the treated water may be 4 mg/L. In particular, it may be confirmed that, when the concentration of barium hydroxide is 5,000 mg/L, the concentration of sulfate ions in the treated water drastically decreases.

It may be confirmed that the concentration of sulfate ions in the treated water is 2,300 mg/L in Comparative Example 1, whereas the concentration of sulfate ions in the treated water is 4 mg/L in Example 6. It may be confirmed that, because the concentration of sulfate ions in the wastewater is reduced from 91,744 mg/L to 4 mg/L, the wastewater treatment method of the inventive concept has achieved a sulfate ion removal efficiency of 99.9 %.

That is, the wastewater treatment method of the inventive concept may effectively reduce the concentration of sulfate ions in the wastewater by using calcium hydroxide, 2-propanol, and barium hydroxide together and using a combination of a barium sulfate precipitation reaction, a calcium sulfate precipitation reaction, and an effect of 2-propanol accelerating sulfate ion precipitation.

As used herein, the term “about” in reference to a numerical value or range is intended to account for variations that may arise due to limitations in measurement precision and variability in fabrication or experimental techniques that would be recognized by one of ordinary skill in the art. The degree of permissible variation may depend on the specific context, including the sensitivity of the value to the operation or effect described. In general, “about” is intended to encompass values that are close enough to achieve substantially the same technical result or function as the stated value or range.

Heretofore, the inventive concept has been particularly shown and described with reference to implementations thereof and the accompanying drawings. Although the implementations have been described herein by using particular terms, these terms used herein are only for describing the inventive concept and are not intended to limit the scope of the inventive concept, which is defined by the appended claims. Therefore, it will be understood by those of ordinary skill in the art that there may be various modifications and equivalent implementations made from the implementations of the inventive concept. Therefore, the scope of the inventive concept should be defined by the appended claims.

What is claimed is:

1. A wastewater treatment apparatus comprising:
a first storage tank configured to store wastewater comprising sulfate ions;
a first reactor configured to generate, based on receiving the wastewater and an aqueous calcium salt, calcium sulfate;
a second reactor configured to generate, based on a first effluent and hydrophilic alcohol, calcium sulfate, wherein the second reactor is configured to receive the first effluent from the first reactor;
a first separator configured to separate calcium sulfate from a second effluent, wherein the first separator is configured to receive the second effluent from the first reactor;
a third reactor configured to generate barium sulfate based on a third effluent and an aqueous barium salt, wherein the third reactor is configured to receive the third effluent from the first separator;
a second separator configured to separate barium sulfate from a fourth effluent, wherein the second separator is configured to receive the fourth effluent from the third reactor; and
a second storage tank configured to store treated water from the second separator.

2. The wastewater treatment apparatus of claim 1, wherein the aqueous calcium salt comprises calcium hydroxide (Ca(OH)₂), and
wherein the wastewater in the first reactor has a pH that is greater than or equal to about 5 and less than or equal to about 7.

3. The wastewater treatment apparatus of claim 1, wherein the hydrophilic alcohol comprises 2-propanol, and
wherein a concentration of the 2-propanol greater than or equal to about 10,000 mg/L and less than equal to about 100,000 mg/L.

4. The wastewater treatment apparatus of claim 1, wherein the aqueous barium salt comprises barium hydroxide (Ba(OH)₂), and
wherein a concentration of the barium hydroxide is greater than or equal to about 300 mg/L and less than or equal to about 30,000 mg/L.

5. The wastewater treatment apparatus of claim 1, wherein the wastewater comprises the sulfate ions at a concentration greater than or equal to 5,000 mg/L and a pH that is greater than or equal to about 0 and less than or equal to about 3.

6. The wastewater treatment apparatus of claim 1, wherein the first separator comprises a first press device and a first filter,
wherein the first press device and the first filter are configured to separate, based on solid-liquid separation, the calcium sulfate from the second effluent, and
the second separator comprises a second press device and a second filter that are configured to separate, based on solid-liquid separation, the barium sulfate from the fourth effluent.

7. The wastewater treatment apparatus of claim 6, wherein each of the first filter and the second filter comprises polymeric polypropylene, polyethylene, one or more other polymeric materials, or a combination thereof.

8. The wastewater treatment apparatus of claim 6, wherein the first press device is configured to separate, based on solid-liquid separation, the calcium sulfate at a driving pressure greater than or equal to about 0.5 bar and less than or equal to about 15 bar, and
wherein the second press device is configured to separate, based on solid-liquid separation, the barium sulfate at a driving pressure greater than or equal to about 0.5 bar and less than or equal to about 15 bar.

9. The wastewater treatment apparatus of claim 1, further comprising:
a third storage tank configured to store the calcium sulfate from the first separator; and
a fourth storage tank configured to store the barium sulfate from the second separator.

10. A wastewater treatment method comprising:
performing, based on combining an aqueous calcium salt with wastewater comprising sulfate ions, a first reaction, thereby generating calcium sulfate and a first effluent;
performing, based on combining hydrophilic alcohol with the first effluent, a first acceleration reaction, thereby (i) accelerating the generation of the calcium sulfate and (ii) generating a second effluent;
performing a first separation on the second effluent, thereby (i) separating the calcium sulfate from the second effluent and (ii) generating a third effluent;
performing, based on combining an aqueous barium salt with the third effluent, a second reaction, thereby generating barium sulfate and a fourth effluent;
performing second separation on the fourth effluent, thereby separating the barium sulfate from the fourth effluent and generating treated water; and
storing the treated water.

11. The wastewater treatment method of claim 10, comprising:
adjusting, based on performing the first reaction, a pH of the wastewater to a value greater than or equal to about 5 and less than or equal to about 7,
wherein the aqueous calcium salt comprises calcium hydroxide (Ca(OH)₂).

12. The wastewater treatment method of claim 10, wherein the hydrophilic alcohol comprises 2-propanol, and
wherein performing the first acceleration reaction comprises supplying, to the first effluent, the 2-propanol at a concentration greater than or equal to about 10,000 mg/L and less than or equal to about 100,000 mg/L.

13. The wastewater treatment method of claim 10, wherein the aqueous barium salt comprises barium hydroxide (Ba(OH)₂), and
wherein performing the second reaction comprises supplying, to the third effluent, barium hydroxide at a concentration greater than or equal to about 300 mg/L and less than or equal to about 30,000 mg/L.

14. The wastewater treatment method of claim 10, wherein the wastewater comprises the sulfate ions having a concentration greater than or equal to 5,000 mg/L, and
wherein the wastewater has a pH greater than or equal to about 0 and less than or equal to about 3.

15. The wastewater treatment method of claim 10, wherein performing the second reaction further comprises performing, based on reacting the hydrophilic alcohol remaining in the third effluent with the aqueous barium salt, a second acceleration reaction, thereby accelerating the generation of barium sulfate.

16. The wastewater treatment method of claim 10, wherein performing the first separation on the second effluent comprises separating, based on performing solid-liquid separation using a first press device and a first filter, calcium sulfate from the second effluent,
wherein the first filter comprises polymeric polypropylene (PP), polyethylene (PE), one or more other polymeric materials, or a combination thereof, and
wherein the first press device operates at a pressure greater than or equal to about 0.5 bar and less than or equal to about 15 bar.

17. The wastewater treatment method of claim 10, wherein performing the second separation on the fourth effluent comprises:
separating, based on performing solid-liquid separation by using a second press device and a second filter, barium sulfate from the fourth effluent,
wherein the second filter comprises polymeric polypropylene (PP), polyethylene (PE), one or more other polymeric materials, or a combination thereof, and
wherein the second press device operates at a pressure greater than or equal to about 0.5 bar and less than or equal to about 15 bar.

18. A wastewater treatment method comprising:
performing, based on supplying an aqueous calcium salt to wastewater comprising sulfate ions, a first reaction, thereby generating calcium sulfate and a first effluent;
performing, based on supplying an aqueous barium salt to the first effluent, a second reaction, thereby generating barium sulfate and a second effluent;
performing a separation on the second effluent, thereby separating the calcium sulfate and the barium sulfate from the second effluent; and
storing treated water that is filtered based on separating the calcium sulfate and the barium sulfate from the second effluent.

19. The wastewater treatment method of claim 18, further comprising:
adjusting, based on performing the first reaction, a pH of the wastewater to a value greater than or equal to about 5 and less than or equal to about 7,
wherein the aqueous calcium salt comprises calcium hydroxide (Ca(OH)₂).

20. The wastewater treatment method of claim 18, wherein the aqueous barium salt comprises barium hydroxide (Ba(OH)₂), and
wherein performing the second reaction comprises supplying, based on calculating a concentration of the sulfate ions remaining in the first effluent, barium hydroxide to the first effluent.
